(19) United States
(12) Patent Application Publication
(10) Pub. No.: US 2012/0326869 A1
(43) Pub. Date: Dec. 27, 2012

(54) Totally 110 volt AC door alarm system

(76) Inventor: Anthony Peter Romeo, Fair Oaks, CA (US)

(21) Appl. No.: 13/135,011

(22) Filed: Jun. 22, 2011

(51) Int. Cl. G08B 13/08

(52) U.S. Cl. 340/545.1

(57) ABSTRACT

This alarm system operates on 110 volts AC and provides audio and light illumination. Toggle switch (19) with a flat rectangular elongated flexible plastic strip (20) attached to its knob (24) is enclosed in switch box (28) which is mounted on assembly bracket (17). This bracket (17) is fastened adjacent to a door on its swinging side. Switch (19) is connected to an alarm circuit. When a door is opened or closed, it will contact elongated plastic strip (20) which extends beyond the door jamb. This contact will turn knob (24) to its “on” or “off” position, thus activating or deactivating an alarm system. This occurs when a main switch is turned on.

### CROSS-REFERENCE TO RELATED APPLICATIONS

This application claims the benefit of provisional Patent Application No. 61/397,244. Confirmation No. 7725 filed Jun. 7, 2010 and Pending Non-Provisional Application Ser. No. 12/927,979, Confirmation No. 5380, filed Nov. 30, 2010 by the present inventor.

### BACKGROUND

1. Prior Art

The following is a tabulation of some prior art that presently appears relevant:

| Pat. No. | U.S. Patents | Patentee |
|---|---|---|
| 3,978,467 | I976-08-31 | Albert |
| 4,754,263 | I988-06-28 | Trimble |
| D264194 | I982-05-4 | Jaretsky |
| 3,537,094 | I970-10-27 | Hawkins/Mandella |
| 2,866,181 | 1958-12-23 | Gordon |

2. Background of the Invention

This invention relates generally to the field of alarm systems and particularly to battery powered alarm systems. Both battery and this invention's 110 volt AC alarm systems are triggered by a door, and both activate or deactivate an alarm system when a door is opened or closed. This occurs when a main switch is turned on. This 110 volt AC alarm system is simple, reliable and economical and has the ability of placing sound and light illumination in a home or an apartment.

Door battery operated alarm systems do not have this capability and also lose their ability to function when batteries fail.

### DRAWINGS

### Figures

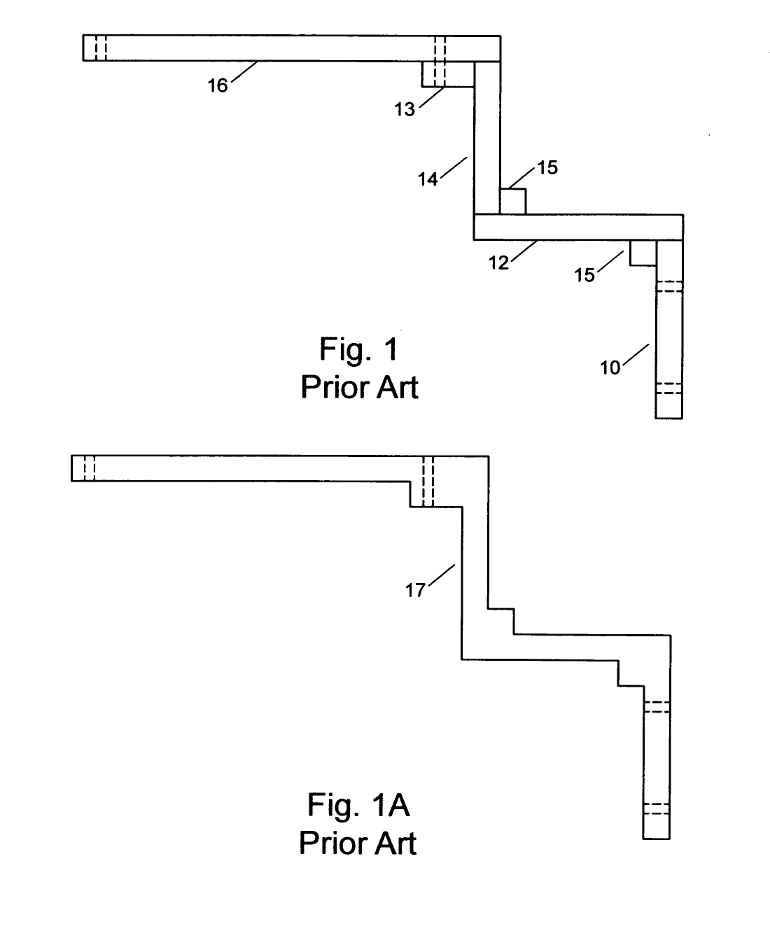

FIG. 1 is a side view of assembly bracket 17 showing components reference numbers 10, 12, 13, 14, 15 and 16.

FIG. 1A is a side view of assembly bracket 17 in an idealized representation.

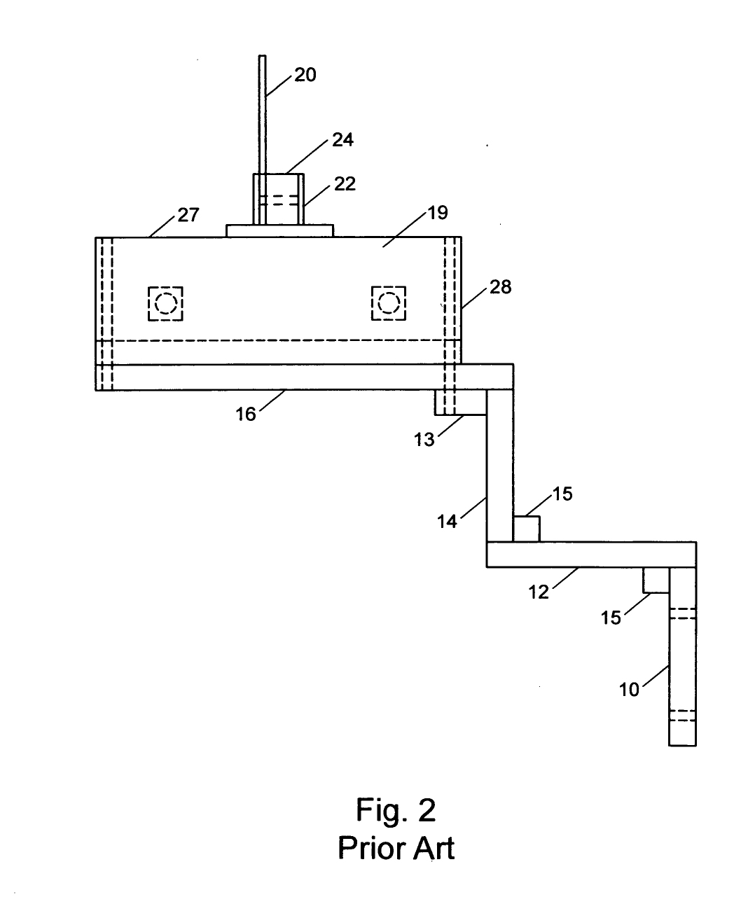

FIG. 2 is a side view of toggle switch box 28 with enclosed toggle switch 19 mounted on assembly bracket 17, component 16.

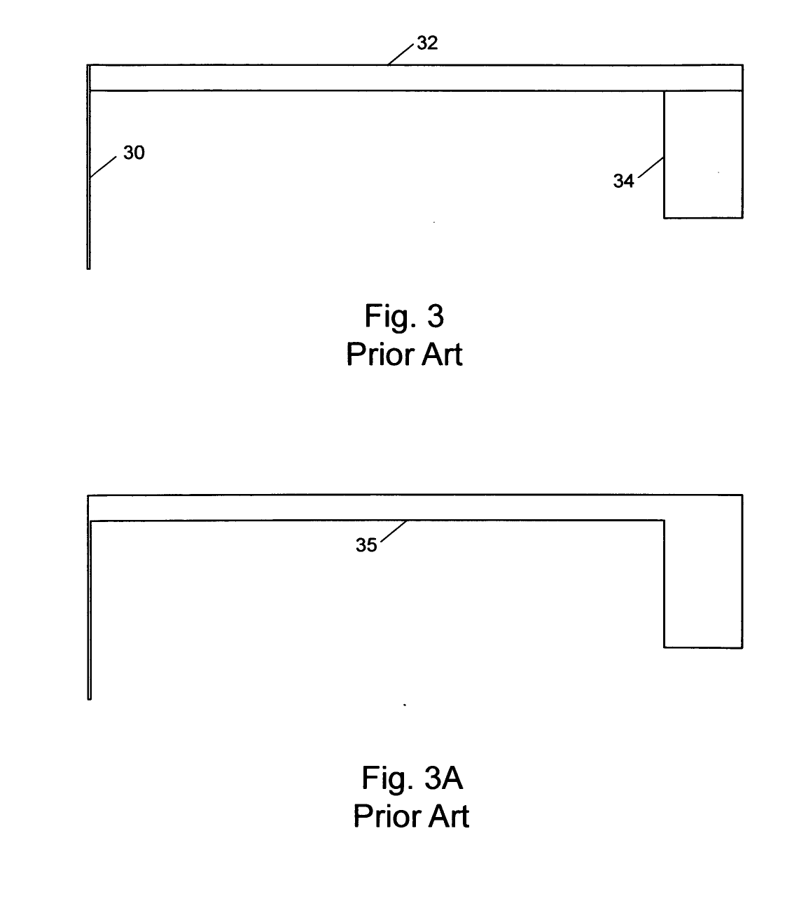

FIG. 3 is a side view of template 35 showing components 30, 32 and 34 that measure the location attaching assembly bracket 17, component 10 to either a wall on the swinging side of a single door or the stationary side of a double door.

FIG. 3A is a side view of template in an idealized representation.

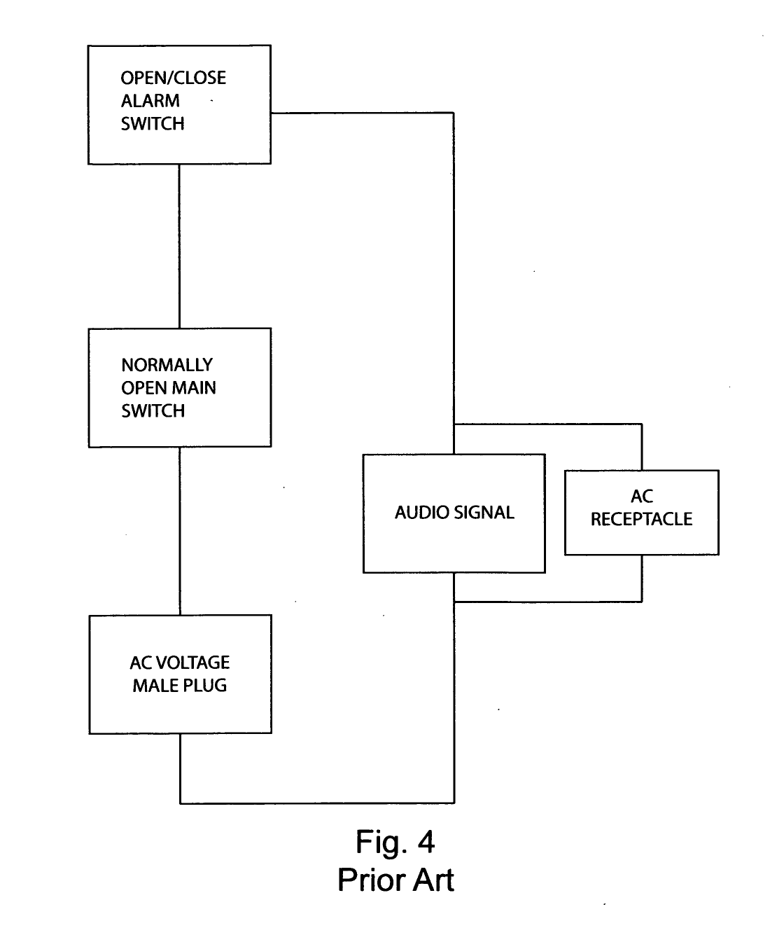

FIG. 4 is a view of non-standard symbol components in an alarm circuit.

Drawings - Reference Numerals

10 bracket 17 component
12 bracket 17 component
13 bracket 17 component
14 bracket 17 component
15 bracket 17 component
16 bracket 17 component
17 bracket 17 in an idealized representation
19 enclosed toggle switch
20 flat rectangular elongated flexible plastic strip
22 heat shrink tubing
24 toggle switch knob
27 switch box cover
28 toggle switch box
30 template component
32 template component
34 template component
35 template in idealized
representation

### DETAILED DESCRIPTION

FIG. 1 is a side view of assembly bracket 17 showing components reference numbers 10, 12, 13, 14, 15 and 16.

Seven (7) each pieces of acrylic pieces are bonded together to fabricate assembly bracket 17. Toggle switch box 28 with an enclosed toggle switch 19 will be mounted on this bracket 17. The bonding material is “Weld On”, distributed by TAP Plastics of Sacramento, Calif.

Measurements pertaining to assembly bracket 17 components are as follows:

| | | | | | REF. |
|---|---|---|---|---|---|
| LENGTH | | WIDTH | | HEIGHT | NO. |
| 4.45 cm | × | 2.54 cm (1 inch) | × | 0.64 cm (¼ inch) | 10 |
| (1¾ inch) | | | | | |
| 5.08 cm (2 inch) | × | 2.54 cm (1 inch) | × | 0.64 cm (¼ inch) | 12 |
| 2.54 cm (1 inch) | × | 1.27 cm (½ inch) | × | 0.64 cm (¼ inch) | 13 |
| 3.81 cm | × | 2.54 cm (1 inch) | × | 0.64 cm (¼ inch) | 14 |
| (1½ inch) | | | | | |
| 2.54 cm (1 inch) | × | 0.64 cm (¼ inch) | × | 0.64 cm (¼ inch) | 15 |
| 10.16 cm (4 inch) | × | 2.54 cm (1 inch) | × | 0.64 cm (¼ inch) | 16 |

Two components 13 and 15 of assembly bracket 17 are bonded to the 90 degree bends of assembly bracket 17, components 10, 12, and 14. Component 13 is bonded to the 90 degree bend of assembly bracket 17, components 14 and 16.

Two (2) each assembly bracket 17 mounting holes 0.40 cm ( 5/32 inch) will be drilled in assembly bracket component 10, 0.64 cm (¼ inch) on the side that is not bonded and 1.91 cm (¾ inch) on the side bonded to component 12. Holes are centered.

Two (2) each 0.40 cm ( 5/32 inch) holes will be drilled in assembly bracket 17, component 16, 0.24 cm ( 3/32 inch) from the side that is not bonded and 1.43 cm ( 9/16 inch) from the side bonded to component 14. Holes are centered.

FIG. 2 is a side view of toggle switch box 28 with an enclosed toggle switch 19 attached to assembly bracket 17, component 16.

A 0.64 cm (¼ inch) wide×3.02 cm (1 3/16 inch) long×0.16 cm ( 1/16 inch) thick flat flexible rectangular elongated plastic strip 20 is cut from a plastic material called Bonding UHMW-PE which due to its molecular makeup is extremely wear, impact and chemically resistant. UHMW-PE is manufactured by Crown Plastics Company, Harrison, Ohio. Position toggle switch knob 24 to its “on” position; while in this position, place the adhesive side of UHMW-PE flat rectangular flexible elongated plastic strip 20, 0.32 cm (⅛ inch) from the rear of switch knob 24 and press down firmly to secure a firm bond.

Measure 0.64 cm (¼ inch) from the front edge of the toggle switch knob 24, center it, and drill a 0.09 cm ( 2/56 inch) hole through knob 24 and flat rectangular flexible elongated strip 20.

Insert a 0.09 cm ( 2/56 inch)×1.27 cm (½ inch) machine screw through switch knob 24 then apply medium strength thread locker “blue” to screw end. Tighten with a 0.09 cm ( 2/56 inch) nut. Then put a 1.27 cm (½ inch)×1.27 cm (½ inch) heat shrink 22 around knob 24 and apply heat. Insert single pole, single throw 15/20 A, 120/277 volt AC/CA toggle switch 19 into switch box 28.

Circuit wiring is then inserted into switch box 28 and wired into toggle switch 19. Attach toggle switch 19 to switch box 28 utilizing machine screws that come with toggle switch 19.

Then attach toggle switch box 28 to assembly bracket 17, component 16 using two (2) each 0.40 cm ( 5/32 inch)×5.08 cm (2 inch) machine screws and tighten with 0.40 cm ( 5/32 inch) nuts and lock washers. Attach cover 27 to switch box 28. Make sure that switch knob 24 is on the “off” position when attaching assembly bracket 17, component 10 to either a wall or on the swinging side of a single door or the stationary side of a double door. Enclosed switch is manufactured by Liviton Mfg. Co., Mellville, N.Y.

FIG. 3 is a side view of template 35 showing components 30, 32 and 34 that measure the location of attaching assembly bracket 17, component 10, to either a wall on the swinging side of a single door or the stationary side of a double door.

FIG. 3A is a side view of template 35 in an idealized representation. Measurements pertaining to template FIG. 3 are as follows:

| | | | | | REF. |
|---|---|---|---|---|---|
| LENGTH | | WIDTH | | HEIGHT | NO. |
| 5.08 cm (2 inch) | × | 1.91 cm (¾ inch) | × | 0.610 mm | 30 |
| | | | | (0.024 inch) | |
| 15.88 cm | × | 1.91 cm (¾ inch) | × | 0.64 cm (¼ inch) | 32 |
| (6¼ inch) | | | | | |
| 3.18 cm | × | 1.91 cm (¾ inch) | × | 1.91 cm (¾ inch) | 34 |
| (1¼ inch) | | | | | |

Component 30 is bonded to one side of wood component 32. Wood component 34 is bonded to the other side of component 32. Gorilla glue bonds them.

For a single door on the swinging side, place aluminum extension 30 of template 35 in the small opening between the door and the door jamb, 3 inches below top of door. Then draw a small vertical line on the wall at the other end of template 35, component 34. Place the right side of assembly bracket 17, component 10, on the line and then attach assembly bracket 17 to the wall.

For a double door, on the swinging side, place aluminum extension 30 of template 35 in the small opening between the swinging door and the stationary door 3 inches below top of door. Then draw a small vertical line at the other end of template 35, component 34, place the right side of assembly bracket 17, component 10, on the line and then attach assembly bracket 17 to the stationary side of the double door.

FIG. 4 is a view of non-standard symbol components in an alarm circuit. Wall mount the following: A main 15 amp, 120 volt AC single pole, single throw toggle switch, PIEZO Audio Signal PS3, and a 15 amp receptacle which will accommodate a light bulb adapter electric socket. The main toggle switch, PIEZO Audio Signal PS3, and 15 amp receptacle will then be wired in series with a 110 AC male plug and open/close alarm switch. Then wire 15 amp receptacle in parallel with PIEZO PS3.

### Novel Feature:

A flat rectangular flexible elongated strip attached to knob 24 of toggle switch 19 is believed to be entirely new.

I claim:

1. An alarm system in which a switch box with an enclosed toggle switch with a flat rectangular flexible elongated plastic strip attached to its knob is mounted on an assembly bracket adjacent to the swinging side of a door. This switch is connected to an alarm circuit. When a door is opened or closed, it will contact the elongated plastic strip which extends beyond the door jamb. This contact will turn the switch knob to its “on” or “off” position thus activating or deactivating an alarm system. This occurs when a main switch is turned on.

2. An alarm system in which the elongated plastic strip of claim 1 whose body of material is composed of polyethylene.

3. An alarm system in which the elongated plastic strip of claim 1 due to its molecular makeup is extremely wear and impact resistant.

4. An alarm system that utilizes an assembly bracket which, in addition to having a switch box with an enclosed toggle switch mounted on it, also provides clearance over door frame moldings when attached to wall.

5. An alarm system that uses no batteries or sensors. It uses 110 volt AC only.
